(19) United States
(12) Patent Application Publication
(10) Pub. No.: US 2023/0142820 A1
(43) Pub. Date: May 11, 2023

(54) NEURON CIRCUIT WITH ONE BIRISTOR AND TWO TRANSISTORS, AND DEVICES INCLUDING THE SAME

(71) Applicant: SAMSUNG ELECTRONICS CO., LTD., Suwon-si (KR)

(72) Inventors: Yang-Kyu CHOI, Daejeon (KR); Joon-Kyu HAN, Daejeon (KR)

(73) Assignee: Korea Advanced Institute of Science and Technology, Daejeon (KR)

(21) Appl. No.: 17/969,006

(22) Filed: Oct. 19, 2022

(30) Foreign Application Priority Data
Nov. 10, 2021 (KR) 10-2021-0154130
Apr. 19, 2022 (KR) 10-2022-0048365

(51) Int. Cl. G06N 3/063

(52) U.S. Cl. CPC G06N 3/063

(57) ABSTRACT

According to an embodiment of the present disclosure, a neuron circuit may be provided. The neuron circuit includes a biristor that includes a collector electrode receiving a constant input current from a first synapse circuit and an emitter electrode connected with a ground and outputs a collector signal through the collector electrode, and a voltage divider that is enabled by the collector signal, performs voltage division on an operating voltage by using values of resistances included therein, and outputs an output voltage corresponding to a result of the voltage division to a second synapse circuit.

### CROSS-REFERENCE TO RELATED APPLICATIONS

This application claims priority under 35 U.S.C. § 119 to Korean Patent Application Nos. 10-2021-0154130 filed on Nov. 10, 2021, and 10-2022-0048365 filed on Apr. 19, 2022, in the Korean Intellectual Property Office, the disclosures of which are incorporated by reference herein in their entireties.

### BACKGROUND

### 1. Field

Embodiments of the present disclosure described herein relate to a neuron circuit, and more particularly, relate to a neuron circuit including one bistable resistor (hereinafter referred to as a “biristor”) and two transistors, and devices including the same.

### 2. Description of the Related Art

In the era of the 4th industrial revolution, artificial intelligence systems are being actively developed. Among the artificial intelligence systems, a neuromorphic computing system that gets out of the existing von Neumann architecture, which consumes a lot of energy, is in the spotlight.

Neuromorphic computing refers to a way to implement artificial intelligence operations through the imitation of the human brain in hardware. Even though the human brain performs very complex functions, the brain consumes only 20 watts (W) of energy. Because neuromorphic computing mimics the structure of the human brain itself, neuromorphic computing makes it possible to perform the following abilities superior to existing computing: the ability to associate, the ability to infer, the ability to recognize, and the ability to process data.

In particular, as an example of neuromorphic computing, spiking neural networks (SNNs) are called the third-generation artificial neural network model. The SNNs that are a neural network model based on the biological learning and signal transmission of the biological brain reduce a considerable amount of energy consumption. For this reason, the SNNs are being actively developed.

Among hardware components for implementing the SNNs, a neuron circuit is implemented with a leaky integrate-and-fire (LIF) neuron circuit that receives a current signal from a previous synapse circuit and transmits a voltage signal to a next synapse circuit as firing when a level of the received current signal exceeds a given level.

A complex circuit that includes a capacitor, an integrator, a comparator, and a reset circuit is used for the neuron circuit performing the LIF operation. However, because the actual human brain has 100 billion neurons, there is a need to improve the degree of integration of neuronal circuits.

### SUMMARY

According to an embodiment, a neuron circuit includes a biristor that includes a collector electrode receiving a constant input current from a first synapse circuit and an emitter electrode connected with a ground and outputs a collector signal through the collector electrode, and a voltage divider that is enabled by the collector signal, performs voltage division on an operating voltage by using values of resistances included therein, and outputs an output voltage corresponding to a result of the voltage division to a second synapse circuit.

According to an embodiment, a neural processing unit (NPU) includes a neuromorphic circuit. The neuromorphic circuit includes a first synapse circuit, a second synapse circuit, and a neuron circuit connected between the first synapse circuit and the second synapse circuit. The neuron circuit includes a biristor that includes a collector electrode receiving a constant input current from the first synapse circuit and an emitter electrode connected with a ground and outputs a collector signal through the collector electrode, and a voltage divider that is enabled by the collector signal, performs voltage division on an operating voltage by using values of resistances included therein, and outputs an output voltage corresponding to a result of the voltage division to the second synapse circuit.

According to an embodiment, a data processing device includes a neural processing unit (NPU) including a neuromorphic circuit. The neuromorphic circuit includes a first synapse circuit, a second synapse circuit, and a neuron circuit connected between the first synapse circuit and the second synapse circuit. The neuron circuit includes a biristor that includes a collector electrode receiving a constant input current from the first synapse circuit and an emitter electrode connected with a ground and outputs a collector signal through the collector electrode, and a voltage divider that is enabled by the collector signal, performs voltage division on an operating voltage by using values of resistances included therein, and outputs an output voltage corresponding to a result of the voltage division to the second synapse circuit.

The biristor includes a bipolar NPN transistor, and a base electrode of the bipolar NPN transistor is in a floating state.

The voltage divider includes a first transistor that includes a first electrode connected with a voltage line supplying the operating voltage, a second electrode connected with an output node outputting the output voltage, and a first control terminal connected with the collector electrode, and a second transistor that includes a third electrode connected with the output node, a fourth electrode connected with the ground, and a second control terminal, the first transistor has a first value of the resistance values, and the second transistor has a second value of the resistance values.

### BRIEF DESCRIPTION OF THE DRAWINGS

Features will become apparent to those of skill in the art by describing in detail example embodiments with reference to the attached drawings in which:

FIG. 1 is a block diagram of a neuromorphic circuit including synapse circuits and neuron circuits according to an example embodiment.

FIG. 2 is a circuit diagram of a first neuron circuit of FIG. 1, which includes one biristor and two transistors.

FIG. 3A is a diagram illustrating a waveform of an output signal to a time of a first neuron circuit illustrated in FIG. 2.

FIG. 3B is a diagram illustrating a waveform of a current flowing to two serially-connected transistors illustrated in FIG. 2.

FIG. 4 is a view illustrating a scanning electron microscope image of a biristor illustrated in FIG. 2.

FIG. 5 is a block diagram of a data processing device including a neural processing unit (NPU) including a neuromorphic circuit illustrated in FIG. 1.

### DETAILED DESCRIPTION

Neuromorphic engineering, which may include neuromorphic computing including a neuron circuit according to an example embodiment, may be applied to a very-large-scale integration (VLSI) system that includes electronic circuits for the purpose of mimicking neuro-biological architectures present in a nervous system.

A neuromorphic computer or neuromorphic chip that includes neuron circuits according to an example embodiment includes all devices that use physical artificial neurons (e.g., physical artificial neurons manufactured by using silicon (or semiconductor)) for the purpose of performing computations. The neuromorphic circuit that includes a neuron circuit according to an example embodiment may be a circuit that is capable of efficiently processing a large amount of data through imitating nerve cells and synapses of the human brain.

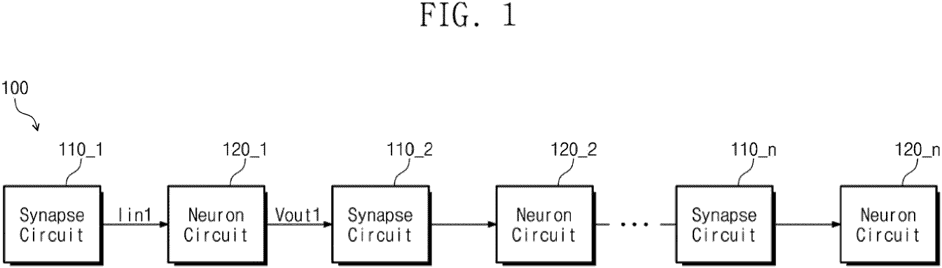

FIG. 1 is a block diagram of a neuromorphic circuit including synapse circuits and neuron circuits according to an example embodiment.

Referring to FIG. 1, a neuromorphic circuit 100 that is implemented with an integrated circuit (IC) may include a plurality of synapse circuits 110_1 to 110_n and a plurality of neuron circuits 120_1 to 120_n. Herein, “n” is a natural number of 3 or more.

The neuromorphic circuit 100 refers to a neural network of circuits composed of artificial neurons or nodes.

Each of the synapse circuits 110_1 to 110_n may be implemented as a volatile memory device or a nonvolatile memory device. For example, each of the synapse circuits 110_1 to 110_n may include a static random access memory (SRAM), a resistive memory (RRAM or ReRAM), a memory resistor (alternatively referred to as “memristor”), a charge trap flash (CTF) memory, a phase-change memory (PCM), a ferroelectric random access memory (FeRAM), or the like.

Each of the neuron circuits 120_1 to 120_n may perform a leaky integrate-and-fire (LIF) function, and may be enabled according to a constant input current output from each of the synapse circuits 110_1 to 110_n. Each of the neuron circuits 120_1 to 120_n may divide an operating voltage supplied to each of the neuron circuits 120_1 to 120_n by using values of resistances included therein, and thus may adjust a magnitude or a pulse width of an output voltage of each of the neuron circuits 120_1 to 120_n.

The LIF function refers to a function of receiving a current signal output from a previous synapse circuit and transmitting a voltage signal to a next synapse circuit as firing when a level of the received current signal is equal to or greater than a given level. Accordingly, each of the neuron circuits 120_1 to 120_n may also be called an LIF neuron.

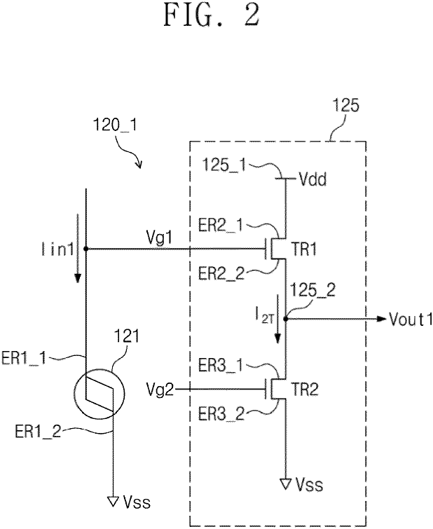

FIG. 2 is a circuit diagram of a first neuron circuit of FIG. 1, which includes one biristor and two transistors.

Because the neuron circuits 120_1 to 120_n illustrated in FIG. 1 are identical to each other in structure and operation, the structure and operation of the first neuron circuit 120_1 will be described as representative.

Referring to FIGS. 1 and 2, the first neuron circuit 120_1 includes one bistable resistor (hereinafter referred to as a “biristor”) 121 and two transistors TR1 and TR2. The first neuron circuit 120_1 receives a constant input current Iin1 from the first synapse circuit 110_1 and outputs a first output voltage Vout1, whose magnitude and pulse width are adjusted, to the second synapse circuit 110_2.

The biristor 121, which is also called a single-transistor neuron, may be implemented with a bipolar NPN transistor. The bipolar NPN transistor 121 includes a base electrode being in a floating state, a collector electrode ER1_1 supplied with the constant input current Iin1 from the first synapse circuit 110_1, and an emitter electrode ER1_2 connected with a ground Vss.

A symbol of the biristor 121 is expressed by a bistable hysteric loop of current-voltage (I-V) characteristics by a single-transistor latch (STL) phenomenon.

A first control electrode of the first transistor TR1 is connected with the collector electrode ER1_1 of the biristor 121. A first electrode ER2_1 of the first transistor TR1 is connected with a voltage line 125_1 supplying an operating voltage Vdd. A second electrode ER2_2 of the first transistor TR1 is connected with an output terminal 125_2.

A second control voltage Vg2 is supplied to a second control electrode of the second transistor TR2. A first electrode ER3_1 of the second transistor TR2 is connected with the output terminal 125_2. A second electrode ER3_2 of the second transistor TR2 is connected with the ground Vss.

According to example embodiments, the first transistor TR1 may be implemented with an n-type metal-oxide-semiconductor field-effect transistor (MOSFET), a p-type MOSFET, a bipolar NPN transistor, or a bipolar PNP transistor. Also, the second transistor TR2 may be implemented with an n-type MOSFET, a p-type MOSFET, a bipolar NPN transistor, or a bipolar PNP transistor.

For example, when each of the first and second transistors TR1 and TR2 is implemented with the MOSFET, each of the first electrodes ER2_1 and ER3_1 may be one of a drain electrode and a source electrode, each of the second electrodes ER2_2 and ER3_2 is the other of the drain electrode and the source electrode, and each of the control electrodes is a gate electrode.

Also for example, when each of the first and second transistors TR1 and TR2 is implemented with the bipolar transistor, each of the first electrodes ER2_1 and ER3_1 may be one of a collector electrode and an emitter electrode, each of the second electrodes ER2_2 and ER3_2 is the other of the collector electrode and the emitter electrode, and each of the control electrodes is a base electrode.

The biristor 121 may perform a function of enabling the first neuron circuit 120_1. The first and second transistors TR1 and TR2 function as a voltage divider 125. The voltage divider 125, composed of the first and second transistors TR1 and TR2, may modulate a magnitude and a pulse width of the first output voltage Vout1 for the purpose of reducing power consumption and energy consumption of the first neuron circuit 120_1 and the second synapse circuit 110_2.

When the constant input current Iin1 is supplied to the collector electrode ER1_1 of the biristor 121, a collector signal Vg1 (e.g., a voltage or a current) of the collector electrode ER1_1 is supplied to the first control electrode of the first transistor TR1.

When the second transistor TR2 is turned on depending on a second control signal (e.g., the second control voltage Vg2) supplied to the second control electrode of the second transistor TR2, the first output voltage Vout1 of the output terminal 125_2 according to the voltage division rule is expressed by Equation 1 below:

$$V o u t 1 = \frac{V d d * {R}_{T R 2}}{\left({R}_{T R 1} + {R}_{T R 2}\right)}$$

In Equation 1, R_{TR1} represents a resistance value of the first transistor TR1 (first resistance), and R_{TR2} represents a resistance value of the second transistor TR2 (second resistance).

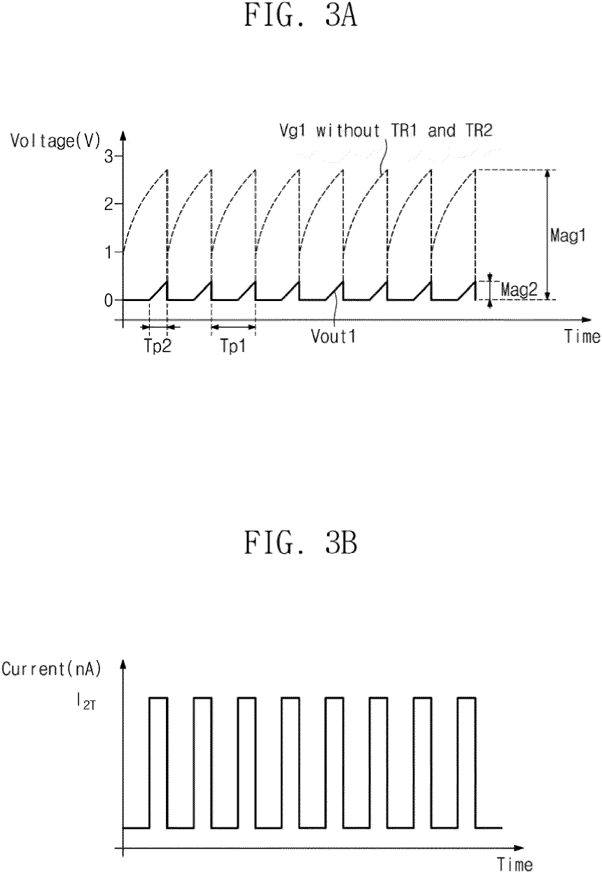

FIG. 3A is a diagram illustrating a waveform of an output signal to a time, for a first neuron circuit illustrated in FIG. 2.

FIG. 3A shows a result of simulation that is made under the condition that the constant input current Iin1 is 5 nA, a threshold voltage of the first transistor TR1 is 2 V, a threshold voltage of the second transistor TR2 is 0 V, the operating voltage Vdd is 1 V, and a voltage of the second control signal (e.g., the second control voltage Vg2) is 0.2 V.

Referring to FIG. 3A, when the first and second transistors TR1 and TR2 are implemented in the first neuron circuit 120_1, a magnitude Mag2 and a pulse width Tp2 of the first output voltage Vout1 of the output terminal 125_2 decreases considerably, compared to a magnitude Mag1 and a pulse width Tp1 of the collector electrode ER1_1 of the biristor 121 when the first and second transistors TR1 and TR2 are not implemented in the first neuron circuit 120_1.

FIG. 3B is a diagram illustrating a waveform of a current flowing to two serially-connected transistors illustrated in FIG. 2.

A waveform of a current I_{2T} flowing through the first and second transistors TR1 and TR2 under conditions identical to the conditions of FIG. 3A is illustrated in FIG. 3B. The current I_{2T} determines energy consumption of the first neuron circuit 120_1.

As the magnitude Mag2 and the pulse width Tp2 of the first output voltage Vout1 of the first neuron circuit 120_1 decreases, energy consumption of the second synapse circuit 110_2 connected with the first neuron circuit 120_1 may decrease.

FIG. 4 is a view illustrating a scanning electron microscope (SEM) image of a biristor illustrated in FIG. 2.

Referring to FIG. 4, the biristor 121 includes a substrate 121_1, a floating body 121_2, an emitter 121_3, a collector 121_4, and a base 121_5.

According to an example embodiment, the emitter electrode ER1_2 may be connected with the emitter 121_3, and the collector electrode ER1_1 may be connected with the collector 121_4.

The substrate 121_1 may be formed of a hole barrier material or an electron barrier material. For example, when the substrate 121_1 is formed of a silicon-on-insulator (SOI), the biristor 121 is a silicon-on-insulator transistor (SOI transistor). For example, the substrate 121_1 may be a p-type SOI wafer, the orientation of which is <100>.

The substrate 121_1 may function as a back gate applying a voltage bias, and the hole barrier material (or the electron barrier material) and the floating body 121_2 may be sequentially formed on or above the substrate 121_1.

The hole barrier material (or the electron barrier material) may be formed of a buried oxide.

The floating body 121_2 may be formed on or above the hole barrier material (or the electron barrier material), and holes (or electrons) generated by impact ionization may be integrated in the floating body 121_2, which makes a neuron operation possible.

The emitter 121_3 and the collector 121_4 are formed on opposite sides of the floating body 121_2.

Each of the emitter 121_3 and the collector 121_4 may be formed of one of n-type semiconductor, p-type semiconductor, and metal silicide.

A type of each of the emitter 121_3 and the collector 121_4 may be different from a type of the floating body 121_2. For example, when each of the emitter 121_3 and the collector 121_4 is p-type semiconductor, the floating body 121_2 may be n-type semiconductor. Also for example, when each of the emitter 121_3 and the collector 121_4 is n-type semiconductor, the floating body 121_2 may be p-type semiconductor.

Each of the emitter 121_3 and the collector 121_4 may be formed by at least one of diffusion, solid-phase diffusion, epitaxial growth, selective epitaxial growth, ion implantation, and subsequent heat treatment.

When a current output from a previous synapse circuit is input to each of the emitter 121_3 and the collector 121_4, a voltage signal of a spike shape may be output from each of the emitter 121_3 and the collector 121_4. For example, when a current output from a previous synapse circuit (e.g., first synapse circuit 110_1) is input to collector 121_4 (e.g., first collector electrode ER1_1), voltage level (e.g., Vg1) may be formed on collector 121_4 (e.g., first collector electrode ER1_1).

The base 121_5 may be formed of one of n-type polysilicon, p-type polysilicon, and metal, and the metal may include aluminum (Al), molybdenum (Mo), chromium (Cr), palladium (Pd), platinum (Pt), nickel (Ni), titanium (Ti), tantalum (Ta), tungsten (W), silver (Ag), titanium nitride (TiN), tantalum nitride (TaN), or a combination thereof. A width “W” of the base 121_5 may be 180 nm, and a length “L” of the base 121_5 may be 380 nm.

The biristor 121 may further include an insulating layer for insulating the floating body 121_2 and the base 121_5. The insulating layer may include silicon oxide, silicon nitride, silicon oxynitride, aluminum oxide, hafnium oxide, hafnium oxynitride, zinc oxide, zirconium oxide, hafnium zirconium oxide (HZO), or a combination thereof.

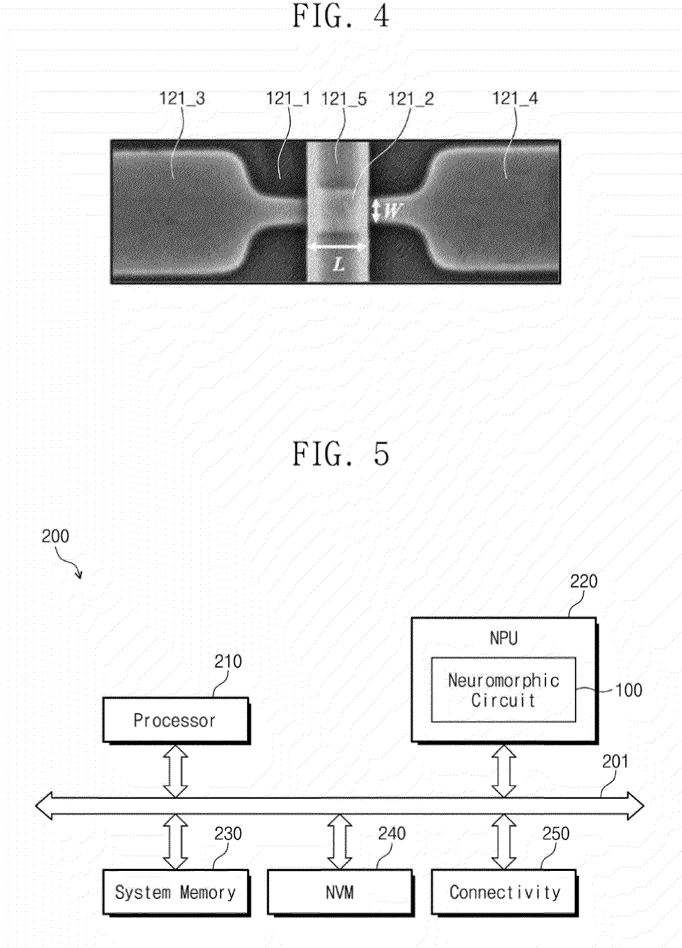

FIG. 5 is a block diagram of a data processing device including a neural processing unit (NPU) including a neuromorphic circuit illustrated in FIG. 1.

Referring to FIG. 5, a data processing device 200 may include a system bus 201, a processor 210, a neural processing unit (NPU) 220, a system memory 230, a nonvolatile memory device 240, and a communication device 250. The communication device 250 is called connectivity.

Examples of the data processing device 200 include an artificial intelligence computing device, a mobile device, an Internet of Things device (IoT device), a drone with a camera, and the like.

Examples of the mobile device include a smartphone, a tablet computer, a laptop computer, a mobile Internet device (MID), a personal digital assistant (PDA), a handheld game console, a portable media player, a digital camera, a wearable computer, and the like.

Examples of the wearable computer include a smartwatch, a head-mounted display (HMD), smart glasses, and the like.

The devices 210, 220, 230, 240, and 250 may exchange information (or data) with each other through the system bus 201.

The processor 210 may collectively indicate at least one of a central processing unit (CPU), a graphics processing unit (GPU), and a data processing unit (DPU). According to an example embodiment, the processor 210 may refer to an application processor (AP).

The NPU 220 refers to a processor that is optimized for the learning and execution of the artificial intelligence processing data through a structure such as a neural network of the human brain. The NPU 220 includes the neuromorphic circuit 100 described with reference to FIGS. 1 to 4.

The system memory 230 may be implemented with a physical memory device such as a random access memory (RAM), or a virtual memory device. Data processed or to be processed by the processor 210 or the NPU 220 may be stored in the system memory 230.

Data processed by, or to be processed by, the processor 210 or the NPU 220 may be stored in the nonvolatile memory device 240. The nonvolatile memory device 240 may be implemented with, e.g., an RRAM (or ReRAM), a memristor, a CTF memory, a PCM, an FeRAM, or the like.

The data processing device 200 may exchange signals (or information) with an external device through the communication device 250. The communication device 250 may collectively refer to one or more of a Wi-Fi communication module, an NFC communication module, a Bluetooth communication module, etc.

A neuron circuit according to an example embodiment may be implemented with one bistable resistor and two transistors performing a role of a voltage divider. Thus, it may be possible to decrease a magnitude of an output voltage of the neuron circuit and a pulse width of the output voltage at the same time. As the magnitude and the pulse width of the output voltage of the neuron circuit decrease, energy consumption of neuromorphic hardware including the neuron circuit may decrease.

As described above, embodiments may provide a neuron circuit that is composed of one biristor and two transistors, which may decrease a magnitude of an output voltage and simultaneously decrease a pulse width of the output voltage, and electronic devices including the neuron circuit.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A neuron circuit, comprising:
a biristor including a collector electrode receiving a constant input current from a first synapse circuit and an emitter electrode connected with a ground, the biristor being configured to output a collector signal through the collector electrode; and
a voltage divider configured to be enabled by the collector signal, to perform voltage division on an operating voltage by using resistances included in the voltage divider, and to output an output voltage corresponding to a result of the voltage division to a second synapse circuit.

2. The neuron circuit as claimed in claim 1, wherein the biristor is a bipolar NPN transistor, wherein a base electrode of the bipolar NPN transistor is in a floating state.

3. The neuron circuit as claimed in claim 1, wherein the biristor is a silicon-on-insulator transistor.

4. The neuron circuit as claimed in claim 1, wherein the biristor is a transistor that includes a substrate functioning as a back gate.

5. The neuron circuit as claimed in claim 1, wherein:
the voltage divider includes:
a first transistor including a first electrode connected with a voltage line supplying the operating voltage, a second electrode connected with an output node outputting the output voltage, and a first control terminal connected with the collector electrode; and
a second transistor including a third electrode connected with the output node, a fourth electrode connected with the ground, and a second control terminal receiving a control voltage,
the first transistor has a first resistance of the resistances included in the voltage divider, and
the second transistor has a second resistance of the resistances included in the voltage divider.

6. The neuron circuit as claimed in claim 5, wherein:
the first transistor is one of an n-type MOSFET, a p-type MOSFET, a bipolar NPN transistor, or a bipolar PNP transistor, and
the second transistor is one of an n-type MOSFET, a p-type MOSFET, a bipolar NPN transistor, or a bipolar PNP transistor.

7. The neuron circuit as claimed in claim 5, wherein:
each of the first transistor and the second transistor is implemented as a MOSFET,
each of the first electrode and the third electrode is one of a drain electrode and a source electrode,
each of the second electrode and the fourth electrode is the other of the drain electrode and the source electrode, and
each of the first control terminal and the second control terminal is a gate electrode.

8. The neuron circuit as claimed in claim 5, wherein:
each of the first transistor and the second transistor is implemented as a bipolar transistor,
each of the first electrode and the third electrode is one of a collector electrode and an emitter electrode,
each of the second electrode and the fourth electrode is the other of the collector electrode and the emitter electrode, and
each of the first control terminal and the second control terminal is a base electrode.

9. A neural processing unit comprising a neuromorphic circuit that includes:
a first synapse circuit;
a second synapse circuit; and
a neuron circuit connected between the first synapse circuit and the second synapse circuit, the neuron circuit including:
a biristor including a collector electrode receiving a constant input current from the first synapse circuit and an emitter electrode connected with a ground, the biristor being configured to output a collector signal through the collector electrode; and
a voltage divider configured to be enabled by the collector signal, to perform voltage division on an operating voltage by using resistances included in the voltage divider, and to output an output voltage corresponding to a result of the voltage division to the second synapse circuit.

10. The neural processing unit as claimed in claim 9, wherein each of the first synapse circuit and the second synapse circuit includes a nonvolatile memory device.

11. The neural processing unit as claimed in claim 9, wherein each of the first synapse circuit and the second synapse circuit includes a volatile memory device.

12. The neural processing unit as claimed in claim 9, wherein:
the biristor is implemented as a bipolar NPN transistor, and
a base electrode of the bipolar NPN transistor is in a floating state.

13. The neural processing unit as claimed in claim 9, wherein:
the voltage divider includes:
a first transistor including a first electrode connected with a voltage line supplying the operating voltage, a second electrode connected with an output node outputting the output voltage, and a first control terminal connected with the collector electrode; and
a second transistor including a third electrode connected with the output node, a fourth electrode connected with the ground, and a second control terminal receiving a control voltage,
the first transistor has a first resistance of the resistances included in the voltage divider, and
the second transistor has a second resistance of the resistances included in the voltage divider.

14. The neural processing unit as claimed in claim 13, wherein:
the first transistor is one of an n-type MOSFET, a p-type MOSFET, a bipolar NPN transistor, or a bipolar PNP transistor, and
the second transistor is one of an n-type MOSFET, a p-type MOSFET, a bipolar NPN transistor, or a bipolar PNP transistor.

15. The neural processing unit as claimed in claim 13, wherein:
each of the first transistor and the second transistor is implemented as a MOSFET,
each of the first electrode and the third electrode is one of a drain electrode and a source electrode,
each of the second electrode and the fourth electrode is the other of the drain electrode and the source electrode, and
each of the first control terminal and the second control terminal is a gate electrode.

16. The neural processing unit as claimed in claim 13, wherein:
each of the first transistor and the second transistor is implemented as a bipolar transistor,
each of the first electrode and the third electrode is one of a collector electrode and an emitter electrode,
each of the second electrode and the fourth electrode is the other of the collector electrode and the emitter electrode, and
each of the first control terminal and the second control terminal is a base electrode.

17. A data processing device comprising a neural processing unit, wherein the neural processing unit includes a neuromorphic circuit that includes:
a first synapse circuit;
a second synapse circuit; and
a neuron circuit connected between the first synapse circuit and the second synapse circuit, the neuron circuit including:
a biristor including a collector electrode receiving a constant input current from the first synapse circuit and an emitter electrode connected with a ground, the biristor being configured to output a collector signal through the collector electrode; and
a voltage divider configured to be enabled by the collector signal, to perform voltage division on an operating voltage by using resistances included in the voltage divider, and to output an output voltage corresponding to a result of the voltage division to the second synapse circuit.

18. The data processing device as claimed in claim 17, wherein:
the biristor is implemented as a bipolar NPN transistor, and
a base electrode of the bipolar NPN transistor is in a floating state.

19. The data processing device as claimed in claim 18, wherein:
the voltage divider includes:
a first transistor including a first electrode connected with a voltage line supplying the operating voltage, a second electrode connected with an output node outputting the output voltage, and a first control terminal connected with the collector electrode; and
a second transistor including a third electrode connected with the output node, a fourth electrode connected with the ground, and a second control terminal receiving a control voltage,
the first transistor has a first resistance of the resistances included in the voltage divider, and
the second transistor has a second resistance of the resistances included in the voltage divider.

20. The data processing device as claimed in claim 17, wherein the data processing device is a mobile device or an Internet of Things device.
